(19) United States
(12) Patent Application Publication
(10) Pub. No.: US 2012/0219726 A1
(43) Pub. Date: Aug. 30, 2012

(54) METHOD AND DEVICE FOR PRODUCING A COMPONENT

(75) Inventors: Erwin Bayer, Dachau (DE); Sven-J. Hiller, Rohrmoos (DE); Karl-Heinz Dusel, Unterschleissheim (DE)

(73) Assignee: MTU AERO ENGINES GMBH, Munchen (DE)

(21) Appl. No.: 13/505,016

(22) PCT Filed: Oct. 30, 2010
(86) PCT No.: PCT/DE2010/001276

§ 371 Date: Apr. 30, 2012

(30) Foreign Application Priority Data
Oct. 31, 2009 (DE) 10 2009 051 552.6

(51) Int. Cl. B05D 3/06; B05C 21/00; B05C 5/00; B05D 3/02; B05D 1/36

(52) U.S. Cl. 427/551; 427/532; 427/203; 427/557; 427/554; 118/300; 118/620

(57) ABSTRACT

The invention relates to a method for producing a component (12), especially a hollow structural part for a turbomachine. The method is characterized by the following steps: a) layer-by-layer deposition of at least one powder component material (20a) onto a component platform in the region of a buildup and joining zone (I), b) deposition of at least one liquid component material (20b) onto the powder component material (20a), the liquid component material (20b) comprising at least one metal-containing compound, c) local layer-by-layer fusion or sintering of the component materials (20a, 20b) by means of thermal and/or electromagnetic energy supplied in the region of the buildup and joining zone (I), d) lowering of the component platform by a predefined layer thickness; and e) repetition of steps a) to d) until the component (12) is finished. The invention further relates to a device (10) for producing a component (12) of a turbomachine, especially a hollow structural part for a turbomachine.

### CROSS-REFERENCE TO RELATED APPLICATIONS

This application is a U.S. National Phase application submitted under 35 U.S.C. §371 of Patent Cooperation Treaty application Ser. No. PCT/DE2010/001276, filed Oct. 30, 2010, and entitled METHOD AND DEVICE FOR PRODUCING A COMPONENT, which application claims priority to German patent application serial no. 10 2009 051 552.6, filed Oct. 31, 2009, and entitled VERFAHREN UND VORRICHTUNG ZUR HERSTELLUNG EINES BAUTEILS.

Patent Cooperation Treaty application Ser. No. PCT/DE2010/001276, published as WO 2011/050791, and German patent application serial no. 10 2009 051 552.6, are incorporated herein by reference.

### TECHNICAL FIELD

The invention relates to a method and a device for producing a component, particularly a hollow component for a turbomachine.

### BACKGROUND

Methods and devices for producing a component, particularly a hollow component of a turbomachine, are known in great number. Known, in particular, are generative manufacturing methods in which the component is constructed layer by layer. In the generative production of components made of metal or a metal ceramic, a very fine-grained component structure is formed in the course of rapid manufacturing or rapid prototyping methods. In rapid manufacturing or rapid prototyping of metal components or of components with metal bonding, primarily fusion or sintering processes are produced by using electromagnetic radiation. For example, the production takes place by laser sintering, laser powder deposition welding, or electron beam deposition welding.

Three-dimensional components may also be produced generatively from a powder bed through layer-by-layer bonding in a pressing process. In order to bond the powder component material used in this process, which comprises ceramic or metal powder, an organic binder is deposited onto a component platform via a printhead. After each partially bonded layer, the component platform is lowered and a new layer of the powder component material is distributed uniformly, spread smooth, and treated with the binder. The powder component material is subsequently sintered or fused together layer by layer through the pointwise action of electromagnetic radiation (laser or electron beams), whereby the binder is cured.

However, a drawback of the known methods and devices is to be seen in the circumstance that the components manufactured in this way have a relatively low heat resistance and a low mechanical stability on account of the organic binder. As a result, components that are to be subjected to strong mechanical and thermal loads, such as, for example, structural components or hollow blades for turbomachines, cannot be produced in this way.

### SUMMARY AND DESCRIPTION

The object of the present invention is to create a method and a device of the kind mentioned in the beginning, which enables a component with improved thermal and mechanical endurance to be produced.

The object is attained in accordance with the invention by a method having the features disclosed and claimed herein as well as a device having the features disclosed and claimed herein. Advantageous embodiments of the invention are presented in the respective dependent claims, advantageous embodiments of the method being regarded as advantageous embodiments of the device and vice versa.

At least the following steps are carried out in accordance with the invention in a method for producing a component, particularly a hollow component for a turbomachine: a) layer-by-layer deposition of at least one powder component material onto a component platform in the region of a buildup and joining zone, b) deposition of at least one liquid component material onto the powder component material, the liquid material comprising at least one metal-containing compound, c) local, layer-by-layer fusion and/or sintering of the component materials by means of thermal and/or electromagnetic energy supplied to the region of the buildup and joining zone, d) lowering of the component platform by a predefined layer thickness, and e) repetition of steps a) to d) until the component is finished. Thus, in contrast to the prior art, a liquid component material is used in addition to the powder component material, the liquid component material comprising a metal-containing compound. When thermal and/or electromagnetic energy is supplied, the metal-containing compound forms metal bonds between the particles of the powder component material, in addition to the fusion and/or sintering of the powder component material, resulting in a component with an appreciably increased thermal and mechanical endurance. Understood here as metal-containing compounds are compounds that can release elemental metals on the atomic level under the influence of thermal and/or electromagnetic energy. For example, elemental metals themselves, metal alloys, intermetallic alloys, complexed metals or metal ions, compounds having covalently bonded and/or ionic metal ions, and/or any suitable mixtures thereof may be provided for this purpose. It can thereby be provided, in principle that the energy in step c) is supplied in accordance with layer information of the component being produced, so as to achieve a particularly high manufacturing precision.

In an advantageous embodiment of the invention, it is provided that a powder component material that comprises a metal and/or a metal alloy and/or an intermetallic compound and/or a metal ceramic and/or a silicate is used in step a). This results in a high level of design freedom in producing the component. In addition, the characteristics of the component can be optimally adapted to its respective intended purpose. It can thereby be provided that compound mixtures and/or different compounds are used for various layers of the component. In addition, through the metal bonding at an atomic level, new alloys can be produced from appropriately blended powder component materials. Thus, for example, metal powders with oxidic admixtures and/or ceramic powders can be blended with one another and used as the powder component material. The metal atoms released from the liquid component material under the influence of the supplied energy can react further in situ or in statu nascendi, depending on the respectively used powder and liquid component materials, and be utilized for the targeted formation of alloys, mixed crystals, and the like.

In another advantageous embodiment of the invention, it has been found advantageous when the choice of a powder size and/or a powder quantity of the powder component material and/or a volume of the liquid component material depends on a layer thickness to be achieved. In this way, the growth of individual component layers may be controlled precisely. In addition, the characteristics profile of the component can be adapted in a targeted and optimal manner to its respective intended use. Preferably taken into consideration in determining the required volume is the concentration of the metal compound in the liquid component material.

In another embodiment, it has hereby been found to be advantageous when, in step b), a liquid component material that comprises an organometallic compound and/or a metal salt and/or nanoparticles and/or a solvent and/or a suspension agent is used. When an organometallic compound is used, the organic group may be cleaved off through thermal and/or electromagnetic energy supplied layer by layer, so that, at the place at which the powder component material is wetted with the liquid, metal bonding ensues. Suitable for metal bonding are, for example, noble metals, which can also be provided as organometallic compounds in the liquid component material. Nanoparticles offer the advantage that their melting or sintering temperature lies markedly below that of the powder component material and, therefore, a particularly reliable bond formation is ensured. In order to be able to optimally adjust the viscosity and wetting properties of the liquid component material, the use of a solvent and/or suspension agent has been found to be advantageous.

Further advantages ensue when, in step b), a liquid component material is used, whose decomposition and/or cleavage and/or sintering and/or melting temperature lies below the melting point of the powder component material. In this way, a particularly reliable bonding of the powder particles is achieved, because it is ensured that the metal-containing compound of the liquid component material is released between the particles of the powder component material before the powder component material melts, conglomerates, and/or sinters.

By depositing the powder and/or liquid component material by means of a printhead, particularly a multiple printhead, the respective component material can be optimally metered and deposited particularly fast. When a multiple printhead is used, the rate of deposition can be additionally increased, the possibility furthermore being provided for deposition of different component materials simultaneously or with a defined spatial distribution.

Further advantages ensue when, prior to step d), at least the steps a) and b) and, if appropriate, c) are carried out simultaneously and/or in reversed sequence and/or repeatedly. In this way, the method can be carried out in a particularly variable manner, so that an optimal adaptability to different component materials is afforded and targeted layer characteristics of the component can be produced in a particularly simple manner.

In another advantageous embodiment of the invention, it is provided that the energy in step c) is supplied by means of a lamp, particularly an IR lamp and/or a flash lamp and/or a high-energy lamp and/or a laser, in particular a CO₂ or Nd:YAG laser, and/or a microwave device. Through the use of strong radiation sources, each component layer can be metalized and bonded together over its surface, this affording corresponding advantages in terms of speed. In addition, excess liquid components of the component material can be removed from the layer by vaporization. When organometallic compounds are used, for example, the organic group can be cleaved off and expelled in a simple manner.

When the method comprises a rapid prototyping and/or rapid manufacturing process, in particular laser deposition welding or electron beam powder deposition welding, geometrically demanding components can also be produced in a particularly fast and cost-effective manner, enabling an appreciable reduction in development and production costs.

In another advantageous embodiment of the invention, it is provided that the shape and/or the material structure of the component is determined as a computer-generated model and layer information generated from it is used to control and/or regulate at least one of the steps a) to e). Accordingly, automated and computer-controlled production processes are possible.

In another advantageous embodiment of the invention, it is provided that, as component, a hollow blade for a turbine or for a compressor of a thermal gas turbine is produced. Particularly during the production of such very finely structured components—for example, hollow structural parts or rotor blades of a turbine or of a compressor of a turbomachine—the various advantages of the method according to the invention particularly come to bear on the speed, cost, and quality of the finished component.

Another aspect of the invention relates to a device for producing a component of a turbomachine, particularly a hollow component for a turbomachine, the production of a component with improved thermal and mechanical endurance being made possible in accordance with the invention in that the device comprises at least one powder feed for deposition of at least one powder component material onto a component platform in the region of a buildup and joining zone, at least one liquid feed for deposition of a liquid component material, which comprises at least one metal-containing compound, onto the component platform in the region of the buildup and joining zone, and at least one energy source for local, layer-by-layer fusion and/or sintering of the component materials by means of thermal and/or electromagnetic energy supplied in the region of the buildup and joining zone. Accordingly, in contrast to the prior art, a liquid component material, which comprises a metal-containing compound, is used in addition to the powder component material. When thermal and/or electromagnetic energy is supplied by means of the energy source, the metal-containing compound can form metal bonds between the particles of the powder component material in addition to the fusion and/or sintering of the powder component material, enabling the production of a component with appreciably increased thermal and mechanical endurance. Understood here as metal-containing compounds are compounds that can release elemental metals atoms under the influence of thermal and/or electromagnetic energy. For example, the following can be provided for this purpose: elemental metals themselves, metal alloys, intermetallic alloys, complexed metals or metal ions, compounds having covalently bonded and/or ionic metal ions, and/or any suitable mixture thereof It can hereby be provided that the powder feed and the liquid feed are integrated into a structural element of the device. It can also be provided that the device comprises at least one storage reservoir coupled with the powder feed and/or the liquid feed, in which at least one of the component materials is held. Furthermore, it can be provided that the device is designed for carrying out a generative manufacturing process, such as, for example, a rapid prototyping or a rapid manufacturing process, in particular laser deposition welding or electron beam (EB) powder deposition welding. Further advantages may be taken from the preceding descriptions, with advantageous embodiments of the method according to the invention being regarded as advantageous embodiments of the device and vice versa.

In another advantageous embodiment of the invention, it is provided that the energy source is a lamp and/or a laser and/or an electron beam device and/or a microwave device. In this case, through the use of strong radiation sources, each component layer can be metalized and bonded over its surface, this affording corresponding advantages in terms of speed. In addition, excess liquid components of the component material can be removed from the layer by vaporization. When organometallic compounds are used, the organic group can be cleaved off and expelled in a simple manner.

In another embodiment, a particularly simple, precise, and fast deposition of the liquid component material is made possible in that the liquid feed comprises a printhead for deposition of the liquid material component. When a multiple printhead is used, the rate of deposition can be additionally increased, the possibility furthermore being provided for deposition of different component materials simultaneously or with a defined spatial distribution.

A particularly uniform distribution of the liquid material component is achieved in another embodiment in that the liquid feed comprises at least one nozzle, through which the liquid component material is deposited onto the component platform. Particularly in combination with the aforementioned printhead technology, it is also possible to provide several nozzles. In this way, the component material can be deposited uniformly at several sites. Alternatively or additionally, it is also possible to deposit different component materials simultaneously at several sites.

Further features of the invention ensue from the claims and the embodiment example as well as on the basis of the drawing. The features and combinations of features mentioned in the description above as well as the features and combinations of features mentioned below in the embodiment example may be used not only in the respectively given combination, but also in other combinations or individually, without departing from the scope of the invention.

### BRIEF DESCRIPTION OF THE DRAWINGS

FIG. 1 shows a schematic illustration of a device for producing a component of a turbomachine.

### DETAILED DESCRIPTION

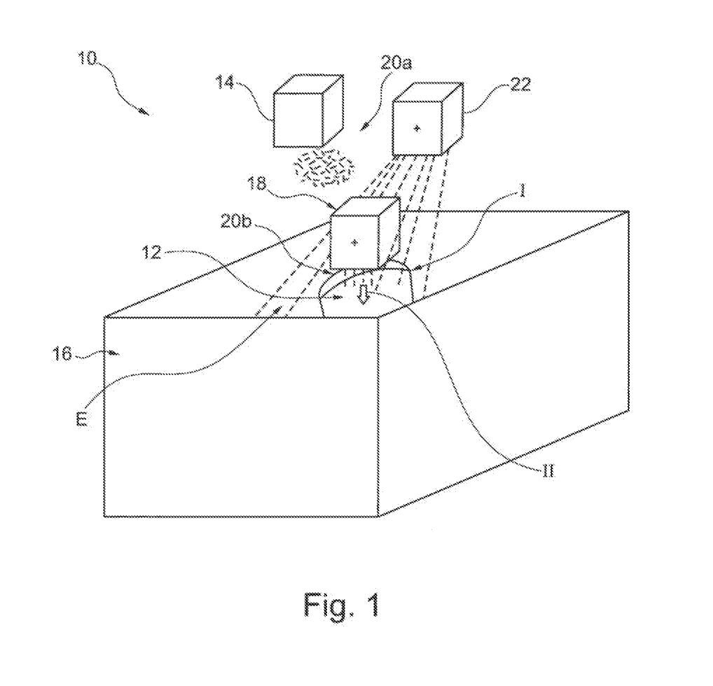

FIG. 1 shows a schematic illustration of a device 10 for producing a component 12 of a turbomachine. The component 12 in the illustrated embodiment example is a blade of a high-pressure turbine. The device 10 serves for the generative production of component 10 and comprises a powder feed 14 for deposition of at least one powder component material 20a onto a component platform (not seen) arranged in a powder container 16 in a movable manner in the region of a buildup and joining zone I. The powder component material 20a here comprises a metallic, ceramic, and/or intermetallic compound. Furthermore, device 10 has a liquid feed 18 for deposition of a liquid component material 20b onto the component platform in the region of buildup and joining zone I, the liquid component material 20b comprising at least one metal-containing compound. The liquid feed 18 here is designed as a printhead and deposits the liquid component material 20b via several nozzles (not seen) onto the powder component material 20a or onto buildup and joining zone I. Here, it may also be provided that powder feed 14 and liquid feed 18 are integrated in a common structural element of device 10.

An energy source 22 is provided for local, layer-by-layer fusion and/or sintering of the component materials 20a, 20b, by means of which thermal and/or electromagnetic energy E is supplied to component 12 in the region of buildup and joining zone I. Energy source 22 may be designed, for example, as a microwave source, a flash lamp, an IR lamp, and/or a high-energy lamp.

Furthermore, device 10 can be coupled with a regulating and/or control device in order to enable the method to be carried out automatically. In this case, the desired shape and/or the desired material structure of component 12 is first determined as a computer-generated model, from which generated layer information is used for controlling and/or regulating device 10.

The manufacture of component 12 will be described below by way of example.

In a first step a), the powder component material 20a is deposited by means of powder feed 14 layer by layer onto the component platform in the region of buildup and joining zone I. Via parameters such as, for instance, the powder size and the powder quantity, it is possible to control the growth of the individual component layers. Subsequently and/or simultaneously, in step b), the liquid component material 20b is deposited by means of liquid feed 18. In the present embodiment example, an organometallic compound taken up in a solvent is used as the liquid component material 20b. Alternatively or additionally, a suspension made up of a liquid suspension agent and nanoparticles may also be used, for example. The use of nanoparticles offers the advantage that the sintering temperature thereof is markedly lower compared to that of the solid or powder component material 20a.

Subsequently, the component materials 20a, 20b are fused or sintered locally layer by layer in step c). For this purpose, thermal and/or electromagnetic energy E is supplied to component 12 in the region of buildup and joining zone I by means of energy source 22. In this way, the metal is released from the liquid component material 20b and bonds with the surrounding powder on an atomic level. This leads to a cross-linking of the powder component material 20a with the metal released from the organometallic compound of the liquid component material 20b. The cleaved organic group as well as the solvent or suspension agent are expelled by the supplied energy E. By contrast, when elemental metals, metal alloys, or nanoparticles are used, only the solvent or suspension agent is expelled by the action of the energy, the released metal or the released alloy being fused or sintered with the powder component material 20a.

Following this step, the component platform is lowered by a predefined layer thickness in the next step d) in accordance with arrow II, after which, in step e), the preceding steps a) to d) are repeated until component 12 is finished.

1-15. (canceled)

16. A method for producing a hollow component for a turbomachine, the method comprising the following steps:
a) depositing layer-by-layer at least one powder component material onto a component platform in the region of a buildup and joining zone;
b) depositing at least one liquid component material onto the powder component material, the liquid component material comprising at least one metal-containing compound;
c) performing at least one of locally fusing and/or locally sintering, layer-by-layer, the powder and liquid component materials by means of at least one of thermal energy and/or electromagnetic energy supplied in the region of the buildup and joining zone;
d) lowering the component platform by a predefined layer thickness; and
e) repeating steps a) to d) until the component is finished.

17. The method according to claim 16, wherein the powder component material used in step a) comprises at least one of:
a metal; and/or
a metal alloy; and/or
an intermetallic compound; and/or
a metal ceramic; and/or
a silicate.

18. The method according to claim 16, wherein the choice of a powder size and/or a powder quantity of the powder component material and/or the choice of a volume of the liquid component material depends on a layer thickness to be achieved.

19. The method according to claim 16, wherein the liquid component material used in step b) comprises at least one of:
an organometallic compound; and/or
a metal salt; and/or
nanoparticles; and/or
a solvent; and/or
a suspension agent.

20. The method according to claim 16, wherein the liquid component material used in step b) has at least one of a decomposition temperature and/or a cleavage temperature and/or a sintering temperature and/or a melting temperature that lies below the melting point of the powder component material.

21. The method according to claim 16, wherein at least one of the powder component material and/or the liquid component material are deposited by means of a printhead.

22. The method according to claim 21, wherein the printhead is a multiple printhead.

23. The method according to claim 16, wherein prior to step d), at least the steps a) and b) are carried out simultaneously and/or in reverse sequence and/or repeatedly.

24. The method according to claim 23, wherein prior to step d), at least the steps a), b) and c) are carried out simultaneously and/or in reverse sequence and/or repeatedly.

25. The method according to claim 16, wherein the energy in step c) is supplied by at least one of:
a lamp; and/or
an IR lamp; and/or
a flash lamp; and/or
a high-energy lamp; and/or
a laser; and/or
a CO₂ laser; and/or
a Nd:YAG laser, and/or
a microwave device.

26. The method according to one of claim 16, wherein the method comprises at least one of:
a rapid prototyping method; and/or
a rapid manufacturing method; and/or
laser deposition welding; and/or
electron beam powder deposition welding.

27. The method according to claim 16, wherein at least one of the shape of the component and/or the material structure of the component is determined as a computer-generated model, from which generated layer information is used for controlling and/or regulating at least one of the steps a) to e).

28. The method according to claim 16, wherein the component produced is one of a hollow vane for a turbine of a thermal gas turbine or a hollow vane for a compressor of a thermal gas turbine.

29. A method for producing a component, the method comprising the following steps:
a) depositing layer-by-layer at least one powder component material onto a component platform in the region of a buildup and joining zone;
b) depositing at least one liquid component material onto the powder component material, the liquid component material comprising at least one metal-containing compound;
c) performing at least one of locally fusing and/or locally sintering, layer-by-layer, the powder and liquid component materials by means of at least one of thermal energy and/or electromagnetic energy supplied in the region of the buildup and joining zone;
d) lowering the component platform by a predefined layer thickness; and
e) repeating steps a) to d) until the component is finished.

30. The method according to claim 29, wherein the powder component material used in step a) comprises at least one of:
a metal; and/or
a metal alloy; and/or
an intermetallic compound; and/or
a metal ceramic; and/or
a silicate.

31. The method according to claim 29, wherein the liquid component material used in step b) comprises at least one of:
an organometallic compound; and/or
a metal salt; and/or
nanoparticles; and/or
a solvent; and/or
a suspension agent.

32. A device for producing a component of a turbomachine, the device comprising:
a component platform;
at least one powder feed configured to deposit at least one powder component material onto the component platform in the region of a buildup and joining zone;
at least one liquid feed configured to deposit a liquid component material that comprises at least one metal-containing compound onto the component platform in the region of the buildup and joining zone; and
at least one energy source configured to perform at least one of locally fusing and/or locally sintering, layer-by-layer, the powder and liquid component materials by means of thermal and/or electromagnetic energy supplied in the region of the buildup and joining zone.

33. The device according to claim 32, wherein the energy source is at least one of:
a lamp; and/or
a laser; and/or
an electron beam device; and/or
a microwave device.

34. The device according to claim 32, wherein the liquid feed comprises a printhead for deposition of the liquid component material.

35. The device according to claim 32, wherein the liquid feed comprises at least one nozzle, through which the liquid component material is deposited onto the component platform.
